(19) United States
(12) Patent Application Publication
(10) Pub. No.: US 2012/0232991 A1
(43) Pub. Date: Sep. 13, 2012

(54) MULTI-MEDIA CATALOG SYSTEM AND METHOD THEREOF

(76) Inventor: Carl Zealer, Canal Winchester, OH (US)

(21) Appl. No.: 13/372,023

(22) Filed: Feb. 13, 2012

Related U.S. Application Data
(60) Provisional application No. 61/442,000, filed on Feb. 11, 2011.
(60) Provisional application No. 61/443,963, filed on Feb. 17, 2011.

(51) Int. Cl. G06Q 30/02

(52) U.S. Cl. 705/14.55

(57) ABSTRACT

A system (and method) of providing a multi-media catalog (or other content, e.g., instructions) is provided. The catalog can be equipped with a multi-media system that includes video and/or audio. The multi-media system can be employed to advertise or otherwise inform a user of a product and/or service. Navigational buttons or switches are used to select content. Additionally, keypads, keyboards, voice recognition or the like is used to select appropriate content.

### CROSS-REFERENCE TO RELATED APPLICATIONS

This application claims the benefit of U.S. Provisional Patent Application Ser. No. 61/442,000 entitled MULTI-MEDIA VIDEO SYSTEM AND METHOD THEREOF filed on Feb. 11, 2011 and to U.S. Provisional Patent Application Ser. No. 61/443,963 entitled MULTI-MEDIA VIDEO SYSTEM AND METHOD THEREOF filed on Feb. 17, 2011. The entireties of the above-noted applications are incorporated by reference herein.

### ORIGIN

The innovation disclosed herein is related to an electronic video system and more specifically, to an electronic catalog video/audio system.

### BACKGROUND

A catalog often refers to trade literature that are often printed materials published by a manufacturer or supplier of products and/or services. The catalog is used to promote or otherwise advertise products and/or services for purchase. In addition to price and availability, oftentimes, a catalog will include specific details and information regarding a product or service, sometimes even including testimonials. Unfortunately, information provided in catalogs is limited and sometimes not useful in describing a product or service in sufficient detail. In addition, catalogs typically become outdated as the design and/or features of the product changes.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system and method of providing a multi-media catalog. In aspects, the catalog can be equipped with a multi-media system that includes video and audio. The multi-media system can be employed to advertise or otherwise inform a user of a product and/or service. Other aspects can include audio, video, still images, individually or in combination thereof.

The innovation disclosed and claimed herein, in another aspect thereof, comprises a system that facilitates product advertisement. The system includes a selection component that facilitates navigation and selection of multi-media content associated to a product or service, a communication component that transmits and/or receives data related to the multi-media content from local and/or remote sources, and a rendering component that transmits the multi-media content to a user.

Still other aspects can employ a single rendering device that communicates with a particular page of a catalog thereby rendering content commensurate with the instant page. In addition to, or in place of auto-detection, the innovation can employ controls that enable a user to select a desired product. For instance, the innovation can include forward and reverse buttons that enable facilitate rotation through pre-programmed content. Other aspects include keypads, keyboards, voice activation or the like to facilitate navigation through content as appropriate or desired.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a product advertisement system in accordance with an aspect of the innovation.

FIG. 2 illustrates an example product advertisement system in accordance with aspects of the innovation.

FIG. 3 illustrates an example product advertisement system in accordance with aspects of the innovation.

FIG. 4 illustrates an example flow chart of procedures that facilitate product advertisement in accordance with an aspect of the innovation.

FIG. 5 illustrates a block diagram of a computer operable to execute the disclosed architecture.

FIG. 6 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

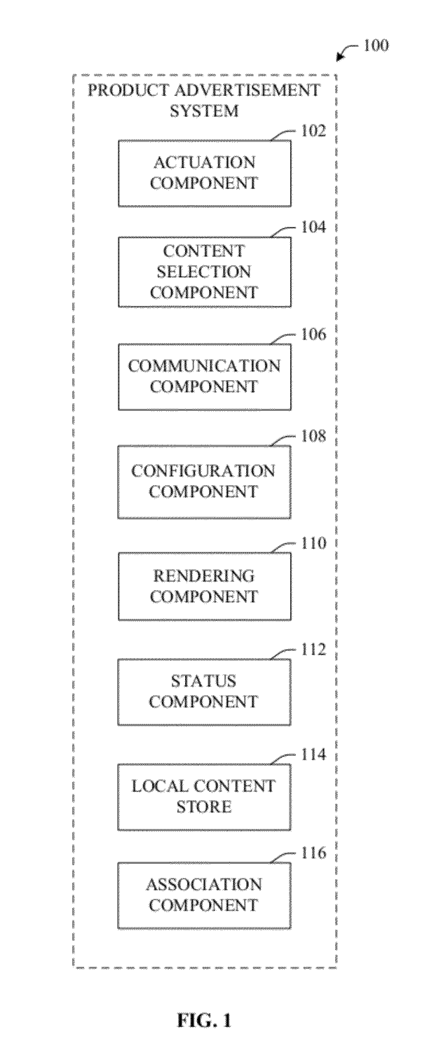

Referring initially to the drawings, FIG. 1 illustrates an example block diagram of a product advertisement system 100 in accordance with aspects of the innovation. In aspects, the system 100 can provide for displaying content, such as but not limited to, a product listing, advertisements, promotional material, or other content, and embodiments can be configured (and optionally reconfigured) to render a variety of content for a product, service, etc. The system 100 can be distributed in a variety of settings in connection with goods and services. For example, the system 100 can be distributed to consumers in stores, malls, at trade shows, etc. or can be shipped to consumers via any parcel service. In various embodiments, the system 100 can be placed in proximity to products or services, and the determined and rendered content can be related to or based at least in part on the proximal products or services.

Generally, the system 100 can include an actuation component 102 to activate the system 100, a content selection component 104 to navigate and select content to be rendered, a communication component 106 that can send or receive content or information related to the rendered content, a configuration component 108 to prepare the content for rendering, a rendering component 110 to render (e.g. visually display, play audio, etc.) the content, a status component 112 to provide the consumer with status information (e.g., inventory, ordering, tracking, etc.), a local content store 114 comprising a memory, and an association component 116 that associates the rendered content with associated content.

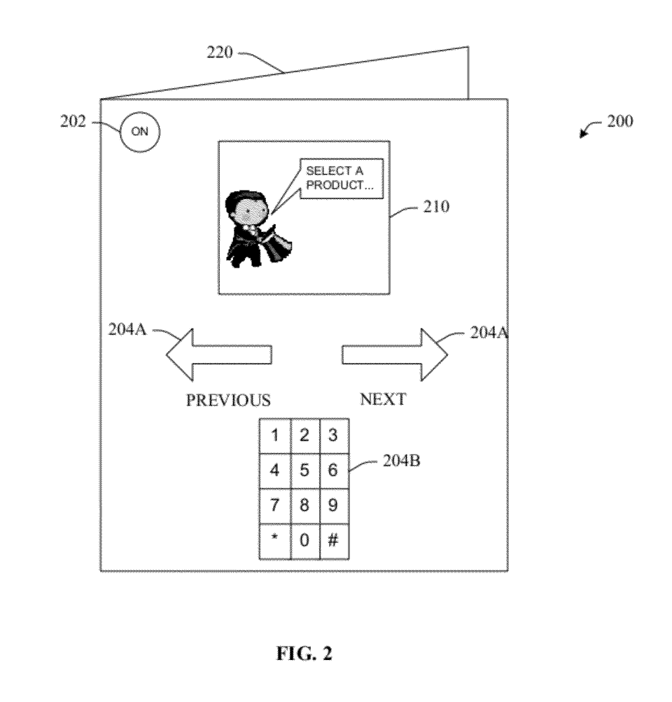

Referring to FIGS. 1 and 2, FIG. 2 illustrates an example advertisement system 100 and more specifically, a portable electronic catalog 200 that facilitates the selection and consumption of products associated with multi-media content in accordance with aspects of the innovation. The actuation component 102, in aspects, can control activation and deactivation of the system 100 and specifically the rendering component 110, such that content can be rendered based at least in part on any of: one or more conditions existing (or not), one or more events occurring (or not), time, random factors (e.g., random number generation, etc.), or other factors. The actuation component 102 can be any type of activation device 202, such as but not limited to, an on/off button, a toggle switch, etc. In other embodiments, the actuation component 102 can be configured, such that the system 100 is activated by simply touching any part of the system 100, voice activated or motion activated (e.g. motion of the system or detect motion of a consumer in close proximity). In addition, in other aspects, the actuation component 102 can be configured to deactivate the system 100 after a predetermined period of inactivity.

As previously mentioned, the content selection component 104 is a navigation and product selection tool for the consumer. The content selection component 104 can include most any input or navigation system including, but not limited to, “previous” and “next” sensitive touch navigation buttons 204A and/or a keypad 204B, touchpads, touchscreen, selection switches, etc. or a combination thereof. In the example embodiment disclosed herein, the buttons 204A are arrow shaped so as to denote “previous” or “next,” which enables a user to toggle through the provided content.

In alternative embodiments, a keyboard can be used to type a product name or code in order to retrieve appropriate content for ultimate display. Still further, the system can be equipped with voice recognition capabilities such that a user can merely speak a product name in order to trigger retrieval of content.

As previously mentioned, the content selection component 104 can also be in the form of a keypad 204B. The keypad 204B can operate in conjunction with or independent of other navigational tools, such as the navigation buttons 202A. In one embodiment, an index (or the like) can be incorporated into the system 100 to select content for display as desired. In another embodiment, the touchpad 204B can also function as navigation keys similar to the navigation buttons 204A.

In another embodiment, the system 100 can be disposed within a publication 220, such as but not limited to a book, catalog, magazine, etc. Thus, the pages of the publication 220 can function as the content selection component 104. Specifically, the pages can communicatively transmit an appropriate identifier that facilities selection of an advertisement. For instance, the pages can be equipped with contacts or the like that communicate to the content selection component 104 thereby effecting appropriate content selection.

The content selection component 104 can select content for system 100 to render in any of a variety of ways in aspects described herein. In some embodiments, content can be provided in connection with system 100, such as via a memory device (e.g., volatile or non-volatile memory; optical, magnetic, solid-state, etc.), for example, a memory card (e.g., a secure digital (SD) card, etc.), stick (e.g., universal serial bus (USB) or other memory device, etc.), which can store on or more items of content. Additionally or alternatively, content can be obtained via communication component 106, such as from the Internet, a local network, peer-to-peer, etc., and can be obtained in a wired (e.g., Ethernet, etc.) or wireless (e.g., Bluetooth, Wi-Fi, radio frequency identification (RFID) devices, etc.) manner. Selection of content by content selection component 104 can be based on any of a number of factors described herein, including information received from one or more other components shown in FIG. 1, as well as upon input from a user (e.g., consumer, employee, etc.).

The communication component 106 can be included to send or receive data to or from system 100 according to various embodiments. This data can be related to items of content, products, or other information, and can be transmitted in a wired or wireless manner, and can involve the Internet, a local or private network, peer-to-peer network, etc. In various embodiments, an application programming interface (API) can be utilized to facilitate sending or receiving data In some aspects, communication component 106 can obtain content from a remote server, which can be based at least in part on other information received. For example, in various aspects, information can be received locally regarding one or more products to be associated with system 100 (e.g., entering information via an input device separate from or included within system 100, receiving information automatically, etc.), and based on the locally received information, communication component 106 can query a server for appropriate content associated with that product, the server can send the content to the product, and communication component 106 can prepare the content for selection, rendering, or other actions (e.g., by sending to the rendering component 110 such as with streamed (live or prerecorded) content, etc.). For example, the consumer can upload updated information on individual products or an entire updated catalog. The consumer can upload status information to check on availability, ordering and tracking information, payment information, etc. Further, the consumer can upload and download information to place an order. In an alternative embodiment, the content can be maintained locally within the advertisement system 100, e.g., on a memory card, flash memory or the like.

The configuration component 108 compiles and prepares the content for rendering by the rendering component 110. The configuration component 108 can be activated upon selection of a desired content by the consumer. The configuration component 108 can prepare content for rendering in a variety of ways. The configuration component 108 can facilitate efficient programming or loading of electronic content for rendering, for example via a display or monitor, speakers, etc. (e.g., rendering component 110). The content can be provided and rendered in any of a variety of formats (e.g., any of a variety of formats as appropriate to the content, which can include, depending on the content, one or more of, audio formats such as .mp3, etc.; video formats such as movie (e.g., .mov, etc.) or picture (e.g., .jpg, etc.) (e.g., comprising a slide show, etc.) formats, etc.), including formats both known or proprietary. Although specific examples are listed, it is to be understood that other formats can be used additionally or alternatively.). The content, e.g., video, advertisement, etc., can be swapped if necessary as described herein, and the configuration component 108 can prepare content either once, each time it is rendered, etc.

In some embodiments, depending on the nature of the rendering component 110, the configuration component 108 can prepare content for rendering in a way that does not preserve all information (e.g., lower sampling or frame rate, lower bit depth, less channels, etc.), for example in connection with a smaller screen, lower quality speakers, etc. In other aspects, content can be initially provided to specific embodiments of system 100 with settings appropriate for system 100 (e.g., by determining appropriate settings either initially or in connection with providing content, etc.). In another example, in some embodiments, ambient levels of lighting or noise can be sensed, and visual or auditory properties of the content can be adjusted dynamically by the configuration component 108 based at least in part on such levels.

Additionally, the configuration component 108 can modify content to be rendered by inserting specific information, such as time, location, customer specific information (on an opt-in basis, to preserve privacy), specific information associated with a store (or mall, trade show, etc.) associated with the system, and other information into content. For example, a product that is currently subject to a sale can render content modified to include information (e.g., as a frame as discussed below, as fixed or scrolling text, etc.) about the sale, potentially a limited duration of the sale, etc. In other aspects, for a customer who opts in, special offers or personalized information can be provided to the customer, e.g., based on detecting an RFID or other device the customer can choose to carry, and querying information either provided by the customer or about the customer (e.g., purchasing habits, associations with other customers who opted in and their purchasing habits, etc., the use of which can be subject to customer approval, modification, etc.). Content can also be modified based on local information that can be provided by a store or other entity associated with one or more of the system or the product or products.

Still referring to FIGS. 1 and 2, the rendering component 110 can include most any multi-media system including, but not limited to, video screen and/or audio capabilities. It will be appreciated that alternative aspects can include video solely. Similarly, audio only aspects are to be included within the scope of the innovation described herein. In the embodiment disclosed herein, the rendering component 110 comprises a video screen 210 as shown and audio (not shown) that communicates with the selection component(s) 204A and/or 204B and memory (not shown). It will be appreciated that appropriate circuitry, memory, etc. can be provided and positioned as desired, for example, within a page or cover portion of a catalog. Further, it will be understood that most any size, orientation, etc. of rendering component(s) can be employed without departing from the spirit and/or scope of the innovation and claims appended hereto.

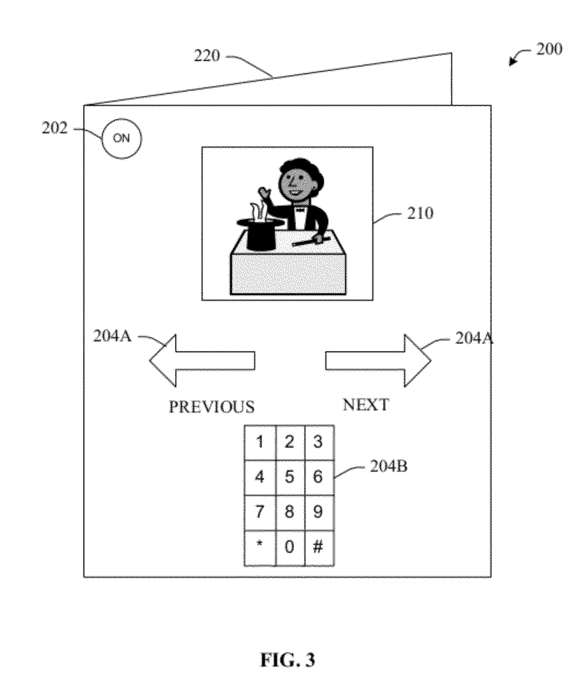

As illustrated, in the example of FIG. 2, a consumer can ‘select a product,’ for example, by depressing appropriate navigational buttons 204A or keys on the touchpad 204B. Once the consumer locates the desired content, the consumer selects the content using the navigational buttons 204A and/or keys 204B. As shown in FIG. 3, an appropriate video is displayed for the consumer to view. It is to be understood, that the content selection component 104 can include an auto-play function to automatically play the content of the system 100 in a systematic or random sequence.

The status component 112 provides the consumer with status information, such as but not limited to, inventory quantities, ordering information, tracking information, payment options, etc. In an example embodiment, the status component 112 can be accessed via the content selection component 104. In another example embodiment, the status component 112 can be accessed through the rendering component 110 (e.g. video touch screen). In still yet another embodiment, the status component 112 can automatically display status information when the desired content is displayed. The status information is transferred via the communication component 106 described above.

Local content store 114 can store content renderable in connection with system 100, as well as other information described herein in connection with systems and methods of the subject innovation. Alternatively or additionally, remote storage can be used for some or all data, and accessed via a communication component 106, including storing data at or near a store, etc., or cloud storage, etc. Any of a variety of types of storage can be used, including various implementations of optical (e.g., CD, DVD, etc.), magnetic (e.g., hard drive, etc.) or solid-state storage devices (e.g., SD card, USB flash memory device, etc.) described herein. In aspects, local content store 114 can be readily removable or updatable, or, in other embodiments, removal and/or update can be more difficult. In various embodiments, replacement of local content store 114 or the data thereon can occur in situ, such as at a store, while in other embodiments, system 100 can be returnable, whereby local content store 114 or the data thereon can be replaced (e.g., by swapping in a new local content store 114, by replacing one or more items of content stored on local content store 114, etc.).

Association component 116 can determine one or more associations that can be used as a basis to determine content to be obtained (e.g., via communication component 106, local content store 114, etc.), or information that content can be modified to include, personalized, etc. (e.g., via configuration component 108, etc.). For example, for certain products, other products can be determined to be frequently purchased in connection with them (e.g., people purchasing printers may need printer cables, ink, paper, etc.; people purchasing a Blu-ray player may want Blu-ray discs, etc.), and information in connection with these other products can be determined and obtained (e.g., via communications component 106, etc.). In other aspects, customers can opt-in or sign up for a rewards or other account associated with a store or other entity associated with the system, wherein promotions, offers, etc. can be personalized to the customer. Some embodiments of system 100 can determine customer-specific content (or modify more generic content to be customer-specific, e.g., via configuration component 108, etc.) to render to the customer, such as upon detection of an RFID or other device a customer may choose to carry. As examples, offers, rewards, etc. can be personalized to customers and presented to them in store near products associated with those offers, rewards, etc., which can be based at least in part on information associated with the customer. Association component 116 can determine content or modifications to content based at least in part on a location (e.g., as recorded in a local content store 114, etc.) of the system (e.g., with varying levels of specificity, such as region, city, mall, etc.), demographics (e.g., associated with the store or other entity connected with the system generally, customers frequently purchasing such items, a specific customer that chooses to opt-in, etc.), a time (e.g., offering content specific to a time of year such as a holiday, a time of day such as dinner-time, etc.), related products, customer membership information, etc.

As an example embodiment, a user can carry or otherwise travel with an embodiment of system 100 along with the user (e.g., by pushing a shopping cart with system 100 the user, etc.), such that as a user changes locations in a store, mall, trade show, etc., system 100 can identify content associated with its present location. For example, this content can be via one or more RFID devices stored in or near products that system 100 can then come in proximity with and obtain content either therefrom or as a result of identifying information received therefrom. In another example, location information can be received, such as via GPS or RFID devices, and that can be associated with content. As an illustration, specific locations can be identified, such as various portions of a store, mall, trade show, etc. that have content associated with those locations (as examples, a store manager might identify types of products or specific products with various aisles or portions of aisles in a store; vendors registering for a trade show can have content related to their products associated with their location in the trade show; etc.). In some aspects, system 100 can also provide further information, including user-provided information, such as presenting a shopping list of the user (e.g., as input on location, scanned or read in by proximity of system 100 to a fob, RFID device, user membership bar code, etc., wherein identifying a rewards or membership account can provide for retrieval of such a list from a remote server or the Internet, such as a list a user entered at home or elsewhere via a computer, mobile device, etc.). Such a system 100 ca use location information over a short period of time to identify whether a user has stopped or slowed in a location, and provide additional information about nearby products. In addition, when presenting content associated with nearby products, this content can include coupons, offers, etc. associated with such products. Additionally, in aspects where a user is identified (e.g., by choosing to sign up for a reward or membership account, etc.), products that the user has previously purchased as well as associated products or products determined to be likely to be purchased by the user can be emphasized when delivering content so as to personalize the content.

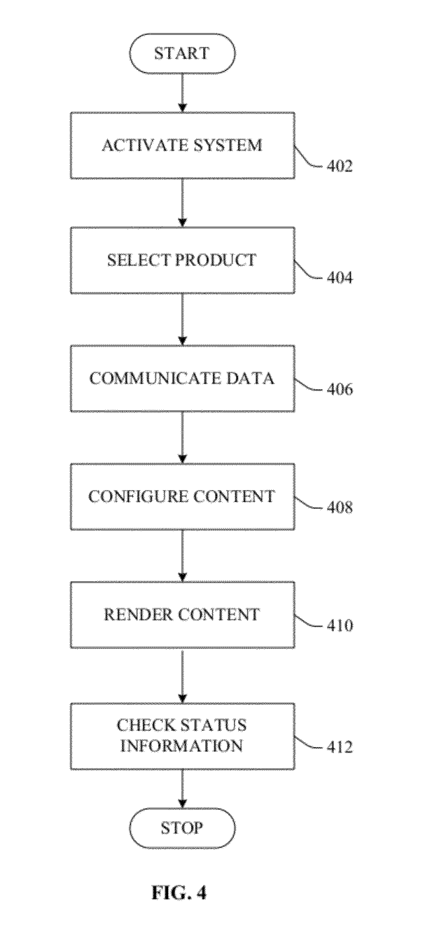

FIG. 4 is an illustration of a method of operating a product advertising system 100 so as to render multi-media content in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 402, the system 100 is activated by a method as disclosed herein. At 404, the consumer navigates the system 100 and selects a desired product (or service). For example, the consumer navigates with the buttons 204A and/or 204B and selects an appropriate video (and/or audio) content selection. At 406, the system 100 transmits and/or receives data from various local and/or remote sources via the communication component 106. Once the consumer retrieves the desired content, at 408, the content is configured for viewing. At 410, the content is transmitted to a user visually via a video screen and/or audibly. At 412, if the consumer has an interest in the content, the consumer can check status information.

While the innovation is directed to advertisement systems generally, it is to be understood that the features, functions and benefits of the innovation can be applied to other applications. For example, the features, functions and benefits of the innovation can be applied to instruction manuals, “How To” videos or the like so as to provide multi-media assistance to a consumer. For instance, upon purchasing a somewhat complicated electronic (or other product), the multi-media system can be used provide a video presentation as to how install, connect, configure, etc.

While this specification described the use of multi-media and other means to promote products and services, it is to be understood that other aspects can employ the features of the innovation in other areas (e.g., education, hobby, cooking, sport, etc.). In aspects, books, folders or the like can include a multi-media rendering system that can retrieve, configure and display content (e.g., still images, audio, video, text, etc.) as desired. In one example, a consumer can select content and upload for rendering. In other aspects, another person (e.g., educator, teacher, parent, etc.) can select and upload content for a user (e.g., student, child, etc.). In another specific embodiment, cooking recipes can be uploaded and stored in a convenient, easy access portfolio or book as desired.

Still further, it is to be understood that a proprietary (e.g., encrypted or otherwise) system (e.g., hardware, format, etc.) can be employed to upload content for rendering. In still other aspects, content can be streamed in real-time (or near real-time) as desired. While certain and specific configurations and orientations of aspects are shown and described herein, other aspects exist that include the features, functions and benefits of the innovation. For instance, the rendering system can be configured inside a book, folder, portfolio, etc. without departing from the spirit and scope of the innovation. These and other aspects are to be included within the scope of the innovation and claims appended hereto.

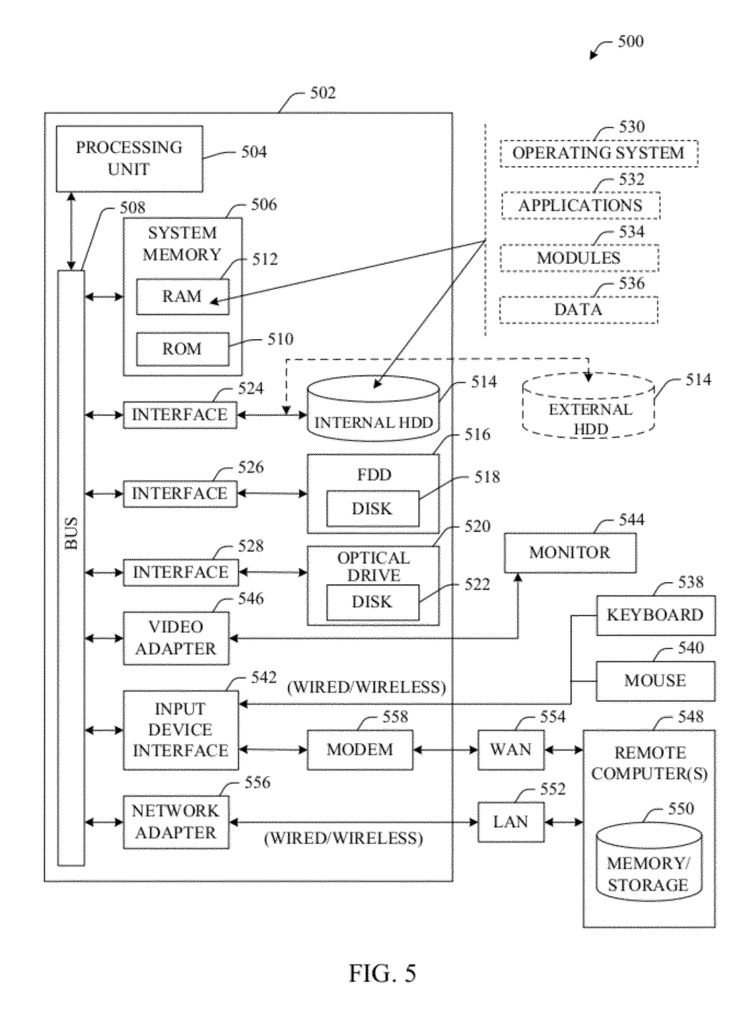

Referring now to FIG. 5, there is illustrated a block diagram of a computer operable to execute the disclosed architecture. In order to provide additional context for various aspects of the subject innovation, FIG. 5 and the following discussion are intended to provide a brief, general description of a suitable computing environment 500 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 5, the exemplary environment 500 for implementing various aspects of the innovation includes a computer 502, the computer 502 including a processing unit 504, a system memory 506 and a system bus 508. The system bus 508 couples system components including, but not limited to, the system memory 506 to the processing unit 504. The processing unit 504 can be any of various commercially available processors. Dual microprocessors and other multi-processor architectures may also be employed as the processing unit 504.

The system bus 508 can be any of several types of bus structure that may further interconnect to a memory bus (with or without a memory controller), a peripheral bus, and a local bus using any of a variety of commercially available bus architectures. The system memory 506 includes read-only memory (ROM) 510 and random access memory (RAM) 512. A basic input/output system (BIOS) is stored in a non-volatile memory 510 such as ROM, EPROM, EEPROM, which BIOS contains the basic routines that help to transfer information between elements within the computer 502, such as during start-up. The RAM 512 can also include a high-speed RAM such as static RAM for caching data.

The computer 502 further includes an internal hard disk drive (HDD) 514 (e.g., EIDE, SATA), which internal hard disk drive 514 may also be configured for external use in a suitable chassis (not shown), a magnetic floppy disk drive (FDD) 516, (e.g., to read from or write to a removable diskette 518) and an optical disk drive 520, (e.g., reading a CD-ROM disk 522 or, to read from or write to other high capacity optical media such as the DVD). The hard disk drive 514, magnetic disk drive 516 and optical disk drive 520 can be connected to the system bus 508 by a hard disk drive interface 524, a magnetic disk drive interface 526 and an optical drive interface 528, respectively. The interface 524 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 512, including an operating system 530, one or more application programs 532, other program modules 534 and program data 536. All or portions of the operating system, applications, modules, and/or data can also be cached in the RAM 512. It is appreciated that the innovation can be implemented with various commercially available operating systems or combinations of operating systems.

A user can enter commands and information into the computer 502 through one or more wired/wireless input devices, e.g., a keyboard 538 and a pointing device, such as a mouse 540. Other input devices (not shown) may include a microphone, an IR remote control, a joystick, a game pad, a stylus pen, touch screen, or the like. These and other input devices are often connected to the processing unit 504 through an input device interface 542 that is coupled to the system bus 508, but can be connected by other interfaces, such as a parallel port, an IEEE 1394 serial port, a game port, a USB port, an IR interface, etc.

A monitor 544 or other type of display device is also connected to the system bus 508 via an interface, such as a video adapter 546. In addition to the monitor 544, a computer typically includes other peripheral output devices (not shown), such as speakers, printers, etc.

The computer 502 may operate in a networked environment using logical connections via wired and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wired/wireless connectivity to a local area network (LAN) 552 and/or larger networks, e.g., a wide area network (WAN) 554. Such LAN and WAN networking environments are commonplace in offices and companies, and facilitate enterprise-wide computer networks, such as intranets, all of which may connect to a global communications network, e.g., the Internet.

When used in a LAN networking environment, the computer 502 is connected to the local network 552 through a wired and/or wireless communication network interface or adapter 556. The adapter 556 may facilitate wired or wireless communication to the LAN 552, which may also include a wireless access point disposed thereon for communicating with the wireless adapter 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wired or wireless device, is connected to the system bus 508 via the serial port interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

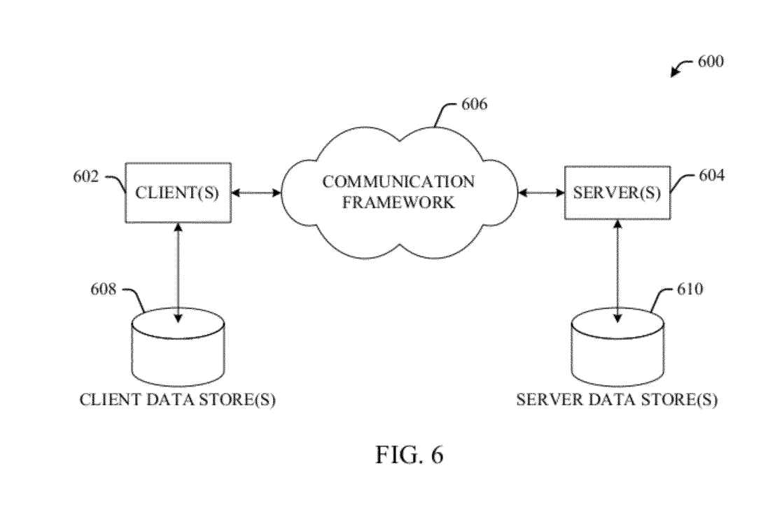

Referring now to FIG. 6, there is illustrated a schematic block diagram of an exemplary computing environment 600 in accordance with the subject innovation. The system 600 includes one or more client(s) 602. The client(s) 602 can be hardware and/or software (e.g., threads, processes, computing devices). The client(s) 602 can house cookie(s) and/or associated contextual information by employing the innovation, for example.

The system 600 also includes one or more server(s) 604. The server(s) 604 can also be hardware and/or software (e.g., threads, processes, computing devices). The servers 604 can house threads to perform transformations by employing the innovation, for example. One possible communication between a client 602 and a server 604 can be in the form of a data packet adapted to be transmitted between two or more computer processes. The data packet may include a cookie and/or associated contextual information, for example. The system 600 includes a communication framework 606 (e.g., a global communication network such as the Internet) that can be employed to facilitate communications between the client(s) 602 and the server(s) 604.

Communications can be facilitated via a wired (including optical fiber) and/or wireless technology. The client(s) 602 are operatively connected to one or more client data store(s) 608 that can be employed to store information local to the client(s) 602 (e.g., cookie(s) and/or associated contextual information). Similarly, the server(s) 604 are operatively connected to one or more server data store(s) 610 that can be employed to store information local to the servers 604.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates product advertisement comprising:
a selection component that facilitates navigation and selection of multi-media content associated to a product or service;
a communication component that transmits and/or receives data related to the multi-media content from local and/or remote sources; and
a rendering component that transmits the multi-media content to a user.

2. The system of claim 1 further comprising an actuation component that controls activation and deactivation of the rendering component, wherein the actuation component includes one of activation/deactivation switches, a voice recognition system or a motion detector system.

3. The system of claim 1 further comprising a status component that provides the user with status information relating to the transmitted multi-media content.

4. The system of claim 3, wherein the status component is accessed via the selection component and/or the rendering component.

5. The system of claim 3, wherein the status component is automatically activated upon rendering of a selected multi-media content.

6. The system of claim 1 further comprising:
a configuration component that prepares the transmitted multi-media content for rendering, wherein the configuration component is activated upon a selection of content by the user;
a local content store to store the transmitted multi-media content locally; and
an association component that associates the transmitted content with associated content.

7. The system of claim 1, wherein the selection component comprises one of a plurality of navigational buttons or switches, a keypad, a keyboard or a touch screen.

8. The system of claim 1, wherein the rendering component is a video and/or audio display system.

9. The system of claim 6, wherein the system is a portable electronic catalog that facilitates the selection and consumption of products associated with the multi-media content.

10. A system that facilitates product advertisement comprising:
a publication;
a selection component that facilitates navigation and selection of multi-media content associated to a product or service; and
a rendering component that transmits the multi-media content to a user,
wherein the selection component and the rendering component are disposed within the publication.

11. The system of claim 10, wherein pages of the publication function as the selection component, such that the pages include a communication means that transmits an identifier facilitating selection of an advertisement.

12. The system of claim 10, wherein the selection component comprises one of a plurality of navigational buttons or switches, a keypad, a keyboard or a touch screen.

13. The system of claim 10 further comprising a communication component that transmits and/or receives data related to the multi-media content from local and/or remote sources.

14. The system of claim 10 further comprising an actuation component that controls activation and deactivation of the rendering component, wherein the actuation component includes one of activation/deactivation switches, a voice recognition system or a motion detector system.

15. The system of claim 10 further comprising a status component that provides the user with status information relating to the transmitted multi-media content.

16. The system of claim 15, wherein the status component is accessed via the selection component and/or the rendering component.

17. The system of claim 10 further comprising:
a configuration component that prepares the transmitted multi-media content for rendering, wherein the configuration component is activated upon a selection of content by the user;
a local content store to store the transmitted multi-media content locally; and
an association component that associates the transmitted content with associated content.

18. The system of claim 10, wherein the rendering component is a video and/or audio display system.

19. A method of rendering multi-media content comprising:
providing a product advertising system;
navigating multi-media content associated to a product or service;
selecting content associated with the product or service via a selection component; and
rendering the selected content, via a rendering component.

20. The method of claim 19, wherein prior to rendering the selected content, via a rendering component, the method further comprising transmitting and/or receiving the multi-media content from local and/or remote sources, and wherein rendering the selected content includes transmitting the multi-media content to a user visually via a video screen and/or audibly

21. The method of claim 20 further comprising checking a status of the selected content.

22. The method of claim 21, wherein the selection component comprises one of a plurality of navigational buttons or switches, a keypad, a keyboard or a touch screen.

23. The method of claim 22, wherein the product advertising system is a portable electronic catalog that facilitates the selection and consumption of products associated with the multi-media content.
